(19) United States
(12) Patent Application Publication
(10) Pub. No.: US 2013/0098546 A1
(43) Pub. Date: Apr. 25, 2013

(54) METHOD FOR FIXING A CRYSTAL TO THE MIDDLE PART OF A WATCH CASE

(71) Applicant: ETA SA Manufacture Horlogere Suisse, Grenchen (CH)

(72) Inventors: Christian Racine, Malleray-Bevilard (CH); Raphael Weyermann, Bienne (CH); Andre Kaltenrieder, Preles (CH)

(73) Assignee: ETA SA Manufacture Horlogere Suisse, Grenchen (CH)

(21) Appl. No.: 13/654,887

(22) Filed: Oct. 18, 2012

(30) Foreign Application Priority Data
Oct. 21, 2011 (EP) 11186181.1

(51) Int. Cl. B32B 37/06

(52) U.S. Cl. 156/272.8

(57) ABSTRACT

Method for fixing a watch crystal (4) to a middle part (2) also made of plastic material, which delimits a watch case (1) with the crystal (4), wherein said watch crystal (4) comprises a top surface (6) facing the user side, and a bottom surface (8) opposite to the top surface (6), and a digital display device (12) is bonded to the bottom surface of the crystal, said method being characterized in that it consists in welding the assembly formed by the crystal (4) and the digital display device (12) to the middle part (2) by means of a laser beam.

This application claims priority from European Patent Application No. 11186181.1 filed 21 Oct. 2011, the entire disclosure of which is incorporated herein by reference.

### FIELD OF THE INVENTION

The present invention concerns a method for fixing a crystal to the middle part of a watch case. More precisely, the invention concerns a method for fixing a watch crystal comprising a top surface facing the user side and a bottom surface, opposite the top surface, with a digital display device bonded to the bottom surface of the crystal.

### BACKGROUND OF THE INVENTION

A first solution for fixing a crystal made of an organic material, such as a plastic material, to the middle part of a watch case which is also made of plastic, lies in the use of bonding techniques. Bonding techniques do not produce mechanical stress or thermal constraints. However, bonding techniques raise other problems. They do not always guarantee a good quality seal and raise problems of wear over time. Moreover, after bonding the parts, a polymerisation time has to be observed, which is usually twenty-four hours. There is thus an interruption in the flow of production, which is detrimental from an economic point of view.

In the case of a watch crystal made of plastic material, it is therefore preferable to use the ultrasound technique for welding this type of crystal to a watch middle part which is also made of plastic. Indeed, the ultrasound welding technique allows the crystal to be secured to the watch middle part in a perfectly sealed and long-lasting manner.

However, there are cases where the ultrasound welding technique is not appropriate. This is particularly true when the elements are sensitive to mechanical and thermal stresses as is the case, in particular, when a liquid crystal display device is bonded to the bottom surface of the crystal. The Applicant has realised that ultrasound welding a watch crystal with a liquid crystal cell bonded to the bottom surface of the crystal causes problems of clustering of the spacers throughout the volume of the liquid crystal cell and is accompanied by the appearance of black spots in the display area of the cell, which is of course unacceptable. In the Applicant's opinion, this spacer clustering problem in the cell volume is due to mechanical vibrations and to the increase in temperature caused by the ultrasound welding.

### SUMMARY OF THE INVENTION

It was therefore an object of the Applicant to overcome the aforementioned problems and to find a new method for fixing a plastic watch crystal to a watch middle part which is also made of plastic.

The present invention therefore concerns a method for securing a plastic watch crystal to a middle part, also made of plastic, which, with the crystal, delimits a watch case, said watch crystal comprising a top surface facing the user side and a bottom surface opposite the top surface, with a digital display device bonded to the bottom surface of the crystal, said method being characterized in that it consists in welding the crystal to the middle part by means of a laser beam.

Owing to these features, the present invention provides a method for fixing a plastic crystal to a plastic watch middle part in a perfectly sealed and long-lasting manner, wherein the crystal has the particular feature of including a digital display device bonded to the bottom surface thereof. In fact, surprisingly, the Applicant observed that laser welding this type of crystal did not in any way affect the mechanical and optical properties of the digital display device. In particular, the laser welding method avoids the problems of spacer clustering observed with the ultrasound welding method, despite the high temperatures involved in laser welding. Moreover, the laser welding method allows instantaneous assembly of the crystal to the middle part of the watch. It is no longer necessary, therefore, to wait, for example for the bond to polymerise, in order to continue with the assembly steps of the watch according to the invention. This represents a considerable time saving and above all, allows a continuous flow of work, with no interruption to the manufacturing method. Moreover, laser welding the bezel provides a solid assembly offering, in particular, excellent resistance to the permanent opposing forces exerted by two flexible connectors as will become clear upon reading the description below.

### BRIEF DESCRIPTION OF THE DRAWINGS

Other features and advantages of the present invention will appear more clearly from the following detailed description of an implementation of the method according to the invention, this example being given solely by way of non-limiting illustration with reference to the annexed drawing, in which:

FIG. 1 is a partial cross-section of a watch case according to the invention.

### DETAILED DESCRIPTION OF THE PREFERRED EMBODIMENTS

The present invention proceeds from the general inventive idea which consists in providing a method for fixing a plastic watch crystal to the plastic middle part of a watch case. A particular feature of the watch crystal is that a digital display device such as a liquid crystal cell is secured by means of an optical adhesive known by the name of Optical Clear Adhesive or OCA to the bottom surface of the crystal, and that the desired fixing method must allow the crystal to be assembled to the middle part of the watch in a perfectly sealed and long-lasting manner, without affecting the mechanical and optical properties of the liquid crystal display device. The Applicant observed that ultrasound welding this type of assembly caused spacers to cluster in the volume of the display cell and the appearance of black spots in the display zone, which is of course unacceptable. In the Applicant's opinion, this phenomenon is due to the mechanical and thermal stresses produced by ultrasound welding. The Applicant therefore continued its efforts and discovered, surprisingly, that despite the thermal constraints imposed, laser welding does not in any way affect the mechanical qualities and optical properties of the liquid crystal display cell bonded underneath the surface of the crystal.

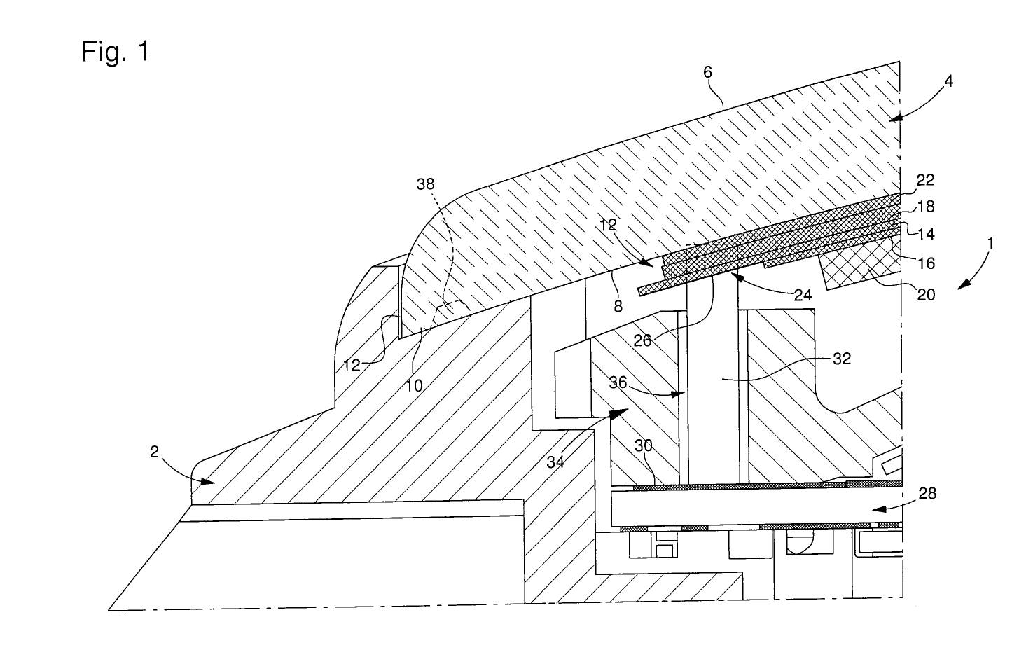

FIG. 1 annexed to this Patent Application is a partial cross-section of a watch case according to the invention. Designated as a whole by the general reference numeral 1, this watch case is delimited by a middle part 2, closed at the top by a crystal 4. Middle part 2 and watch crystal 4 are made of materials that can be laser welded. Purely by way of non-limiting example, crystal 4 is made of poly (methyl methacrylate) or PMMA, while middle part 2 is made of acrylonitrile butadiene styrene or ABS.

Watch crystal 4 has two surfaces, namely a top surface 6 facing the watch user side and a bottom surface 8 facing the watch case 1 side. Crystal 4 abuts on a shoulder 10 of middle part 2.

A digital display device is fixed to the bottom surface 8 of crystal 4. Purely by way of non-limiting example, this digital display device may be a liquid crystal display cell 12 comprising a front substrate 14 and a rear substrate 16 extending in parallel and at a distance from each other and joined to each other by a sealing frame (not visible in the drawing) which delimits a sealed volume containing the liquid crystal in which spacers are dispersed. The two front 14 and rear 16 substrates are arranged between first and second polarisers, respectively 18 and 20, with crossed polarisation directions. The assembly formed by the two substrates 14 and 16 and the two polarisers 18 and 20 is bonded by means of a film of optical adhesive 22 to the bottom surface 8 of watch crystal 4.

It can be seen upon examining the drawing that the dimensions of front substrate 14 exceed those of rear substrate 16. This forms a contact surface 24, onto which the conductive paths 26 open out for the electrical connection of the control electrodes of display cell 12 to the electronic control components (not shown) of cell 12. These electronic control components are mounted on a printed circuit board 28 arranged inside watch case 1, underneath display cell 12 and at a distance therefrom. The conductive paths 26 for the electrical connection of the control electrodes of liquid crystal display cell 12 are connected to corresponding conductive paths 30 structured on the surface of the printed circuit board 28 by means of an elastomeric connector 32 which extends substantially vertically. It will be recalled that an elastomeric connector, also known by the commercial name of a zebra connector, is a flexible connector formed of a plurality of conductive sheets separated from each other by elastomer insulating sheets. The assembly is completed by a light guide 34 which abuts on the printed circuit board 28 and which is used for back lighting liquid crystal display cell 12. It will be noted that light guide 34 includes a slot 36 for guiding and vertically holding zebra connector 32. As it is guided and held, zebra connector 32 can be compressed vertically without, however, moving laterally, which guarantees perfect alignment between conductive paths 26 of liquid crystal display cell 12 and the corresponding connectors carried by printed circuit board 28.

As already mentioned above, crystal 4 abuts on a shoulder 10 of middle part 2. According to the invention, crystal 4 is fixed to middle part 2 by laser welding. For the purposes of the laser weld, an annular collar 38 is provided on the inner periphery of middle part 2. This annular collar 38 is provided at the place where crystal 4 abuts against middle part 2. This collar 38 constitutes an addition of thermoplastic material which will melt during the laser welding process and permanently secure crystal 4 to middle part 2 in a sealed manner. According to a variant of the method of the invention, the collar made of hot melt material which will melt during the laser weld could be located under the external peripheral edge of crystal 4. However, this variant is not preferred since a collar located underneath the surface of crystal 4 would be inconvenient for the operations of bonding and pressing the liquid crystal cell 12 in order to remove any air bubbles which might be trapped in the film of optical adhesive 22 arranged between cell 12 and crystal 4.

According to the invention, the level of shoulder 10 relative to printed circuit board 28 is such that zebra connector 32 is compressed when crystal 4 is laser welded to middle part 2. The compressed portion of zebra connector 32 is shown in dotted lines in the Figure. This particular case reveals all the advantages of the invention. Firstly, since a liquid crystal cell 12 is bonded to the bottom surface 8 of crystal 4, the fact that crystal 4 is laser welded to middle part 2 avoids any risk of damaging cell 12. Secondly, given that zebra connector 32 is arranged compressed between liquid crystal display cell 12 and printed circuit board 28, it tends to try to return to its initial shape and exerts a stress on crystal 4 which tends to detach crystal 4 from middle part 2. Consequently, in the absence of a laser weld between crystal 4 and middle part 2, the assembly formed by said crystal 4 and middle part 2 would have to be bonded and polymerised for at least twenty-four hours under mechanical stress, which would complicate the manufacturing operations and interrupt the flow of production.

It goes without saying that this invention is not limited to the embodiments that have just been described and that various simple alterations and variants can be envisaged by those skilled in the art without departing from the scope of the invention as defined by the annexed claims. In particular, as regards the actual technique of laser welding two parts made of plastic material, reference may be made to EP Patent No. 1 117 502 B2, which discloses the welding parameters, such as the nature of the laser source, the wavelength, energy density, duration of the pulse, preparation of materials etc. It will also be noted that, although this invention has been described in relation to a liquid crystal display cell, other digital display device belonging to OLED or e-ink cell families may also be envisaged within the scope of the invention. However, OLED or e-ink display devices with segments will be preferred.

What is claimed is:

1. A method for fixing a watch crystal made of plastic material to a middle part also made of plastic material, which delimits a watch case with the crystal, wherein said watch crystal comprises a top surface facing the user side, and a bottom surface opposite to the top surface, and a digital display device is bonded to the bottom surface of the crystal, wherein said method consists in welding the assembly formed by the crystal and the digital display device to the middle part by means of a laser beam.

2. The method according to claim 1, wherein, for the purposes of the laser weld, the middle part is provided with an annular collar provided at the place where the crystal abuts against the middle part, said annular collar constituting an addition of thermoplastic material which will melt during the laser welding process to secure the crystal to the middle part.

3. The method according to claim 1, wherein a collar of hot melt material which will melt during the laser weld is located underneath the peripheral edge of the crystal.

4. The method according to claim 1, wherein the digital display device is a liquid crystal cell.

5. The method according to claim 1, wherein a printed circuit board is arranged inside the watch case, underneath the digital display device and at a distance therefrom, the digital display device being electrically connected to the printed circuit board by means of a zebra type electrical connector, the crystal abutting on a shoulder arranged in the middle part, the height of the shoulder relative to the printed circuit board being such that, when the crystal is secured to the shoulder, the zebra connector is compressed between the digital display device and the printed circuit board.

6. The method according to claim 2, wherein a printed circuit board is arranged inside the watch case, underneath the digital display device and at a distance therefrom, the digital display device being electrically connected to the printed circuit board by means of a zebra type electrical connector, the crystal abutting on a shoulder arranged in the middle part, the height of the shoulder relative to the printed circuit board being such that, when the crystal is secured to the shoulder, the zebra connector is compressed between the digital display device and the printed circuit board.

7. The method according to claim 3, wherein a printed circuit board is arranged inside the watch case, underneath the digital display device and at a distance therefrom, the digital display device being electrically connected to the printed circuit board by means of a zebra type electrical connector, the crystal abutting on a shoulder arranged in the middle part, the height of the shoulder relative to the printed circuit board being such that, when the crystal is secured to the shoulder, the zebra connector is compressed between the digital display device and the printed circuit board.

8. The method according to claim 4, wherein a printed circuit board is arranged inside the watch case, underneath the digital display device and at a distance therefrom, the digital display device being electrically connected to the printed circuit board by means of a zebra type electrical connector, the crystal abutting on a shoulder arranged in the middle part, the height of the shoulder relative to the printed circuit board being such that, when the crystal is secured to the shoulder, the zebra connector is compressed between the digital display device and the printed circuit board.

9. The method according to claim 5, wherein the zebra connector is guided and held vertically, as a result of which said connector can be compressed without, however, moving laterally, which guarantees perfect alignment between the conductive paths of the digital display device and the corresponding connectors carried by the printed circuit board.

10. The method according to claim 6, wherein the zebra connector is guided and held vertically, as a result of which said connector can be compressed without, however, moving laterally, which guarantees perfect alignment between the conductive paths of the digital display device and the corresponding connectors carried by the printed circuit board.

11. The method according to claim 7, wherein the zebra connector is guided and held vertically, as a result of which said connector can be compressed without, however, moving laterally, which guarantees perfect alignment between the conductive paths of the digital display device and the corresponding connectors carried by the printed circuit board.

12. The method according to claim 8, wherein the zebra connector is guided and held vertically, as a result of which said connector can be compressed without, however, moving laterally, which guarantees perfect alignment between the conductive paths of the digital display device and the corresponding connectors carried by the printed circuit board.

13. The method according to claim 9, wherein a light guide which is used for back lighting the digital display device includes a slot for guiding and vertically holding the zebra connector.

14. The method according to claim 10, wherein a light guide which is used for back lighting the digital display device includes a slot for guiding and vertically holding the zebra connector.

15. The method according to claim 11, wherein a light guide which is used for back lighting the digital display device includes a slot for guiding and vertically holding the zebra connector.

16. The method according to claim 12, wherein a light guide which is used for back lighting the digital display device includes a slot for guiding and vertically holding the zebra connector.
